(19) United States
(12) Patent Application Publication
(10) Pub. No.: US 2013/0332813 A1
(43) Pub. Date: Dec. 12, 2013

(54) Generic Workspace Awareness Support for Collaborative Web Applications

(71) Applicants: Matthias Heinrich, Dresden (DE); Franz Josef Grueneberger, Walldorf (DE)

(72) Inventors: Matthias Heinrich, Dresden (DE); Franz Josef Grueneberger, Walldorf (DE)

(73) Assignee: SAP AG, Walldorf (DE)

(21) Appl. No.: 13/490,058

(22) Filed: Jun. 6, 2012

(51) Int. Cl. G06F 15/173; G06F 17/00

(52) U.S. Cl. 715/234; 709/224

(57) ABSTRACT

Embodiments relate to systems and methods providing support for generic workspace awareness in collaborative applications. A client-side generic awareness adapter (GAA) may be in communication with a centralized awareness service. Embodiments of the GAA may comprise components for setup, awareness capture, awareness messaging, and/or awareness visualization. By leveraging a DOM Event API to track DOM manipulations, certain embodiments of the GAA capture component may generically capture workspace awareness information. The GAA may further encapsulate awareness widgets (e.g. pointers, cursors, participant lists, document histories, annotated thumbnail views) through a library, thereby promoting their reuse.

### BACKGROUND

Embodiments of the present invention relate to collaborative applications, and in particular, to systems and methods providing generic workspace awareness support.

Unless otherwise indicated herein, the approaches described in this section are not prior art to the claims in this application and are not admitted to be prior art by inclusion in this section.

In general, collaborative applications may help geographically dispersed teams to jointly create and modify documents of various types (e.g. text documents, mind maps, business process diagrams). Carrying out joint tasks in a shared workspace may involve some form of workspace awareness: that is, an up-to-the-moment understanding of another's interaction with the shared space. In essence, workspace awareness allows effective collaborative work to be performed, by answering questions such as “who, what, and where” relating to the workspace (e.g. who is in the workspace? what are other participants doing? where are they working?)

Current collaborative web applications may incorporate individual, application-specific awareness widgets. Thus if N different collaborative tools are to be created and have a need for a particular type of workspace awareness widget, an overall development project would encompass N specific workspace awareness widget implementations, and would also entail the maintenance of N specific awareness widgets. The complexity of such approaches can hinder their effective implementation.

Accordingly, the present disclosure addresses these and other issues with systems and methods providing generic workspace awareness support for collaborative applications.

### SUMMARY

Embodiments relate to systems and methods providing support for generic workspace awareness in collaborative applications. A client-side generic awareness adapter (GAA) may be in communication with a centralized awareness service. Embodiments of the GAA may comprise components for setup, awareness capture, awareness messaging, and/or awareness visualization. By leveraging the DOM Event API to track DOM manipulations, particular embodiments of the capture component of the GAA may generically capture workspace awareness information. The GAA may further encapsulate awareness widgets (e.g. pointers, cursors, participant lists, document histories, annotated thumbnail views) through a library, thereby promoting their reuse.

An embodiment of a computer-implemented method comprises, providing a generic awareness adapter in communication with a non-editor specific layer of a web application, the generic awareness adapter comprising an awareness widget library, a capture component, and a message component. The capture component is caused to capture awareness information communicated from an editor-specific layer to the non-editor specific layer. The message component is caused to reference the awareness widget library and transmit to an awareness service server, an awareness message based upon the awareness information, such that the awareness service server is caused to distribute the awareness message to other clients.

An embodiment of a non-transitory computer readable storage medium embodies a computer program for performing a method. The method comprises providing a generic awareness adapter in communication with a non-editor specific layer of a web application, the generic awareness adapter comprising an awareness widget library, a capture component, and a message component. The capture component is caused to capture awareness information communicated from an editor-specific layer to the non-editor specific layer. The message component is caused to reference the awareness widget library and transmit to an awareness service server, an awareness message based upon the awareness information, such that the awareness service server is caused to distribute the awareness message to other clients.

An embodiment of a computer system comprises one or more processors and a software program executable on said computer system. The software program is configured to provide a generic awareness adapter in communication with a non-editor specific layer of a web application, the generic awareness adapter comprising an awareness widget library, a capture component, and a message component. The software program is configured to cause the capture component to capture awareness information communicated from an editor-specific layer to the non-editor specific layer. The software program is configured to cause the message component to reference the awareness widget library and transmit to an awareness service server, an awareness message based upon the awareness information, such that the awareness service server is caused to distribute the awareness message to other clients.

In certain embodiments the non-editor specific layer comprises a world wide web consortium application programming interface (W3C API), and the awareness information comprises a document object model (DOM) manipulation.

In some embodiments the DOM manipulation occurs according to a DOM Core specification and/or to a DOM Events specification.

According to particular embodiments the awareness information comprises JavaScript Object Notation (JSON) data, the awareness message comprises a JSON string, and the method further comprises causing the message component to serialize the JSON data into the JSON string.

In certain embodiments, the generic awareness adapter further comprises a visualization component configured to communicate the awareness message to an awareness widget of the awareness widget library for visualization.

In some embodiments, the awareness widget library may include a pointer awareness widget, a cursor awareness widget, a document history awareness widget, an annotated thumbnail view awareness widget, or a text highlight awareness widget.

According to particular embodiments, providing the generic awareness adapter in communication with the non-editor specific layer comprises, embedding an extra file name into the web application, and completing a specific configuration file.

The following detailed description and accompanying drawings provide a better understanding of the nature and advantages of particular embodiments.

### BRIEF DESCRIPTION OF THE DRAWINGS

FIG. 1 shows a simplified schematic view of an embodiment of a generic awareness system.

FIG. 2 shows a simplified view of an embodiment of a generic awareness adapter.

FIG. 3 illustrates hardware of a special purpose computing machine configured to perform generic awareness support according to an embodiment.

FIG. 4 illustrates an example of a computer system.

FIG. 5 illustrates a screenshot of an example of a workspace awareness widget enriching a shared text editor.

FIGS. 6-6E illustrate an implementation of a workspace awareness system according to an embodiment.

### DETAILED DESCRIPTION

Described herein are techniques providing support for generic workspace awareness. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Collaborative applications are widespread. The following is a non-exclusive list encompassing common domains for collaborative web applications:
Integrated Development Environments (IDE);
Diagram Editors (BPMN editor, UML editor, etc.);
Office Applications (e.g. WORD and Spreadsheet Processors); and
Graphics Editors (for vector or pixel graphics).

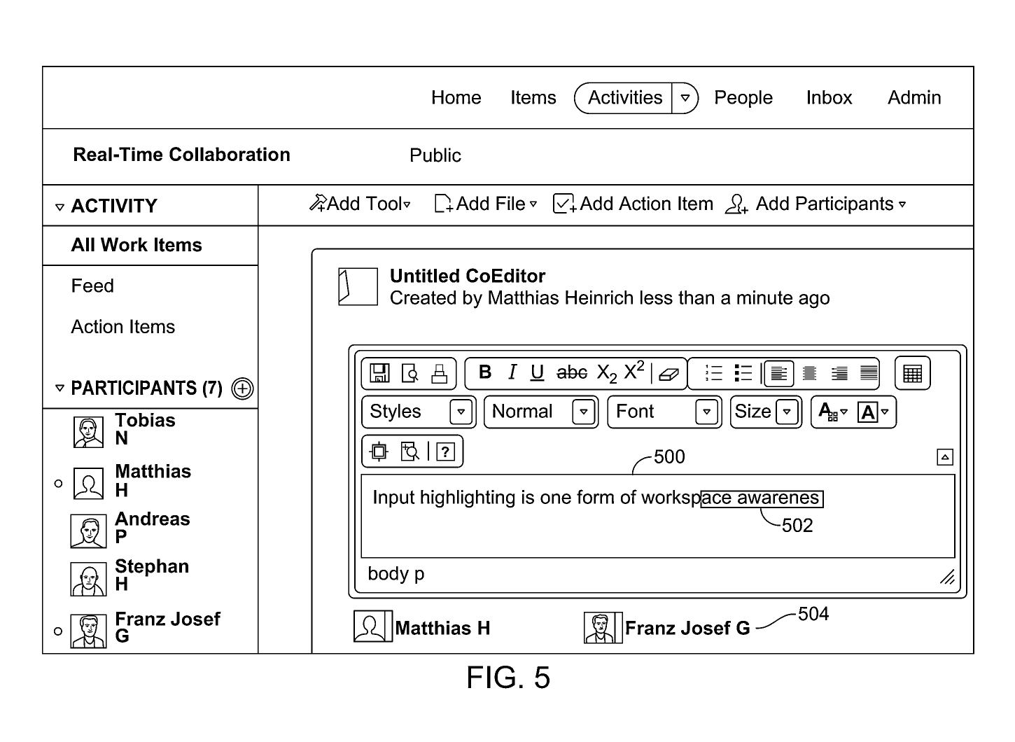

Various collaborative web applications may incorporate individual, application-specific awareness widgets in various forms that provide workspace awareness. One type of workspace awareness widget is shown in FIG. 5. In particular, this workspace awareness widget enriching a shared text editor by delineating user contributions to a document 500 with colored highlighting 502 that is correlated to a participant list 504. In this particular case, darkness of the highlighting indicates an amount of time since the highlighted character was inserted. As time passes the highlighting fade and is not noticeable.

Other types of workspace awareness widgets may utilize symbols or shapes appearing within a document, to identify contributions by collaborators within a workspace. Example of such workspace awareness widgets include cursors or pointers that are labeled with text (e.g. the name of the collaborator), and which may further include color information.

Still other types of workspace awareness widgets may track collaborator contributions with detailed textual information. Examples include document histories identifying revisions by relevant information such as date, time, and responsible contributor (which again may be indicated by color).

Yet other types of workspace awareness widgets may track specific passages within a document that reflect contributions by collaborators. For example a thumbnail view of document pages may be provided, with color bands identifying input from a specific participant. There is also “radar view” widget that can indicate the user's view port in the document, so that each participant knows where others are currently working.

Currently, collaborative web applications rely on specific awareness widgets which do not allow for reuse. As described herein, however, embodiments comprise systems and methods providing generic workspace awareness support for collaborative web applications.

Embodiments may allow consolidation of differing awareness implementations. This can drive cost savings with respect to the development and maintenance of collaborative applications. In addition, embodiments allowing original web applications to reuse the same code base, could also ease governance processes and increase software quality.

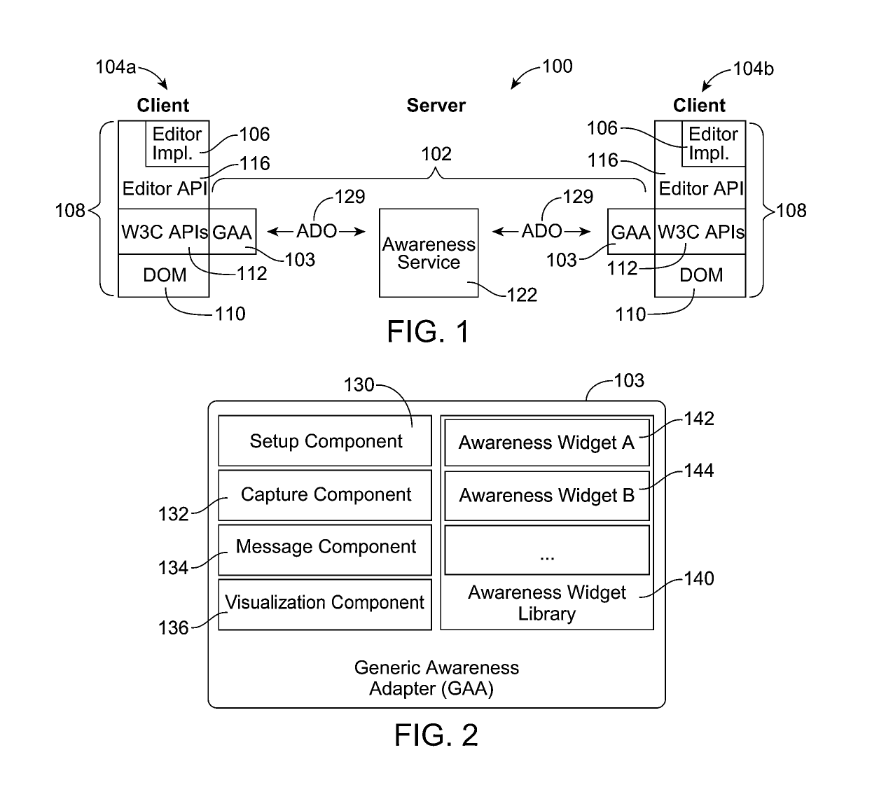

FIG. 1 is a simplified diagram showing a collaborative workspace environment 100 utilizing a generic awareness system (GAS) 102 according to an embodiment. In particular, the collaborative workspace environment comprises a plurality of workspace users corresponding to an arbitrary number of clients (here two clients 104a, 104b).

Each client is configured with an original web application 106, that may be divided into layers 108. In particular, one standardized layer is the document object model (DOM) 110. The DOM may comprise a simple tree representation of a web site or web application in a web browser.

The DOM may be accessed via the DOM API residing at another standardized layer—the world wide web consortium (W3C) application programming interfaces (APIs) layer 112. The W3C APIs define the programming interface to the DOM, and include a DOM Core and a DOM Event specification.

User actions that provide the relevant workspace awareness information, take place in the editor implementation layer 106. This editor implementation layer 106 is in turn in communication with the W3C API 112, via an editor-specific Editor API 116.

Conventionally, workspace awareness information would be communicated by a workspace awareness widget present in the editor implementation layer. By contrast, embodiments as described herein utilize a Generic Awareness Adapter (GAA) to capture workspace awareness information in a generic manner from the editor. As discussed in detail below this GAA monitors DOM manipulations, since registered event listeners are fired if DOM changes occur.

FIG. 1 shows that the DOM cannot be accessed using other APIs (e.g. the Editor API), except through the W3C (DOM) API. Hence, an editor-specific API has to use the methods provided by the DOM API. For example, the editor-specific API might expose a function createCircle( ), which eventually uses the standardized DOM API operations createElement( ) and setAttribute( ) in order to manipulate the DOM in such a way that a circle is created.

Accordingly, embodiments leverage this characteristic of the DOM to provide generic workspace awareness support. In particular, FIG. 1 shows an embodiment of the GAS 102 as comprising a GAA component 103 that is integrated with the existing web applications on the client side.

The GAA is in communication with a central server 122 (e.g. through HTTP channels) that hosts an awareness service. In particular, the GAA may communicate awareness information in the form of an Awareness Data Object (ADO) 129, to the awareness service.

For reasons relating to compatibility and cost, it is desirable that the GAS can be incorporated with the existing web environment in a non-invasive fashion. That is, the source code of the original web applications may not require modification in order to communicate with the GAS.

To achieve this, embodiments may be configured to interface with standardized web-application layers (e.g. the W3C APIs, the DOM), rather than with the editor-specific layers. Such standardized web-application layers only expose one fixed application programming interface (API) instead of numerous editor-specific APIs.

As shown in the specific embodiment of FIG. 1, the GAA component leverages the W3C APIs. Examples include but are not limited to, the DOM Core specification and the DOM Events specification. Consequently, the GAA can be adopted by numerous web-applications relying on standardized W3C APIs.

FIG. 2 shows a detailed view of one particular embodiment of the GAA 103. In particular, FIG. 2 shows awareness widgets 142, 144 bundled in the widget library 140 accommodated by the GAA. The GAA thus encapsulates awareness widgets in the form of this library, while the editor itself may or may not include any awareness widgets.

Accordingly, the GAA promotes reuse since it does not depend on editor-specific implementations or APIs. It only relies on the W3C DOM API that is application-agnostic. Hence, reuse of the GAA and its attached awareness widgets among numerous applications, is possible.

In addition to the awareness widget library, the GAA includes the following components:
(1) a Setup Component 130 that is responsible for the process of setting up the awareness system;
(2) a Capture Component 132 that is responsible for the process of capturing awareness information;
(3) a Message Component 134 that is responsible for the process of propagating awareness messages; and
(4) a Visualization Component 136 that is responsible for preparing awareness information for its visualization.
   Detailed discussion of the function of the elements of the GAA, is now provided in connection with the following Example.

### EXAMPLE

As mentioned above, embodiments may employ a GAA that leverages the W3C APIs of an original web application. Examples of such W3C APIs include but are not limited to, the DOM Core specification and the DOM Events specification.

In this particular example, adopting the GAA is accomplished by embedding an extra JavaScript file name “gaa.js” into the original web application, and completing a specific configuration file “gaa.conf”.

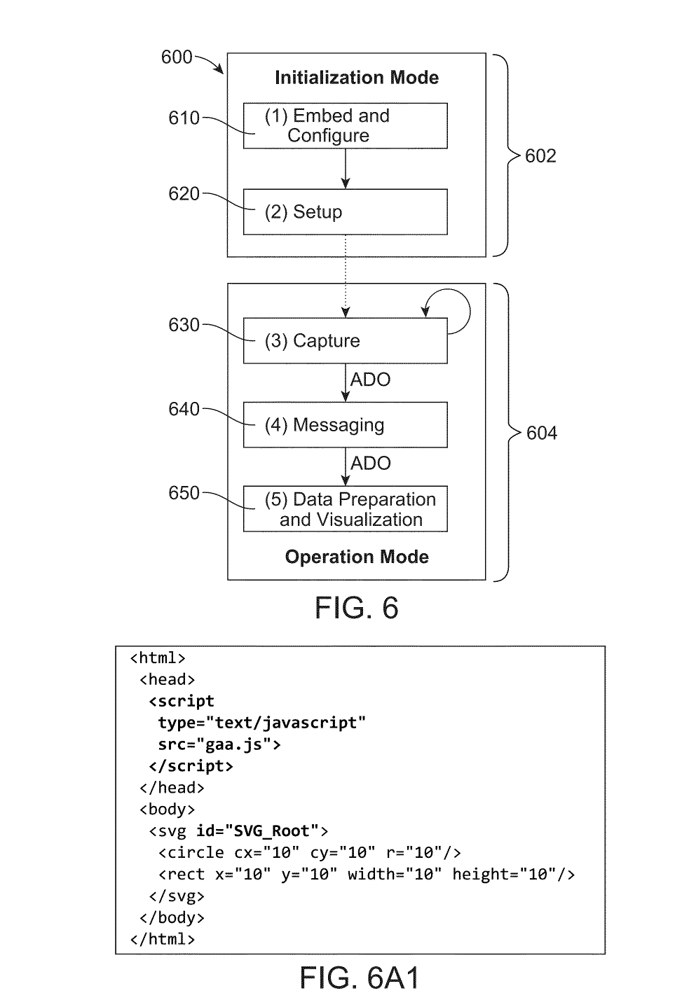

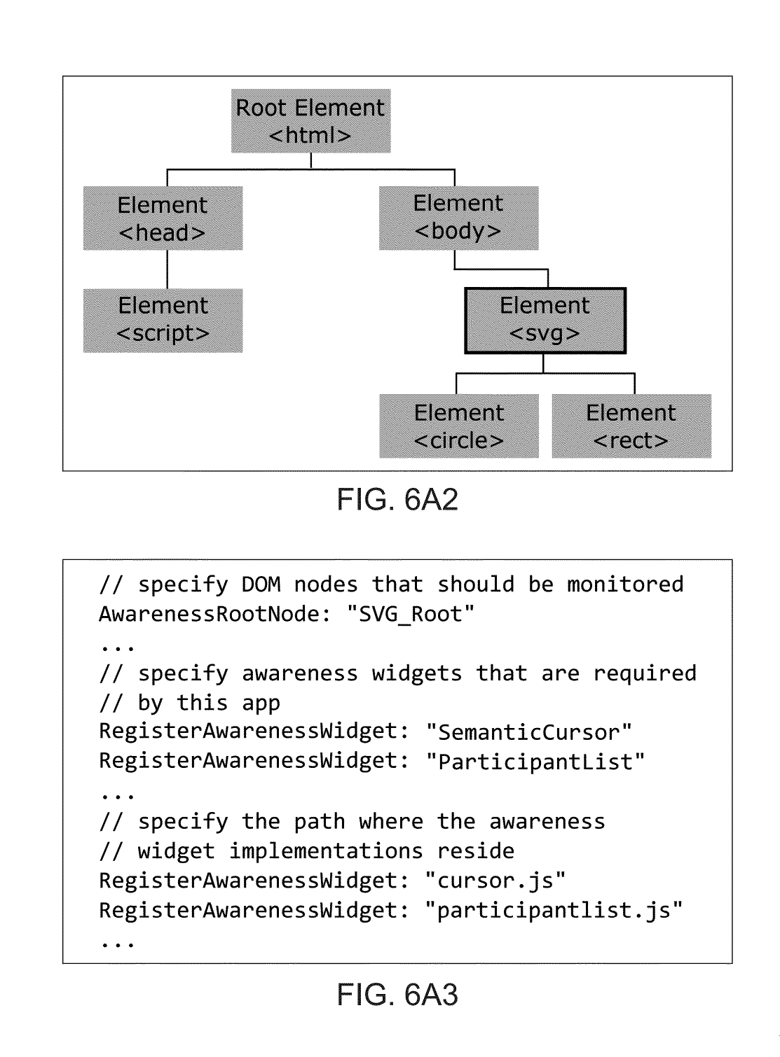

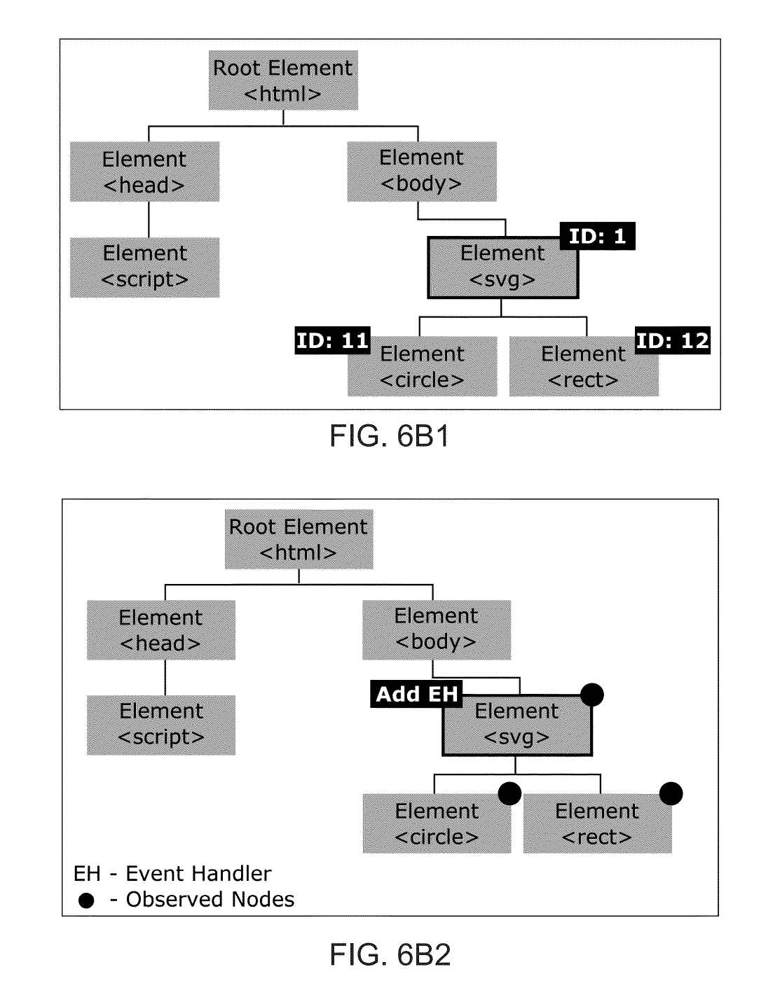

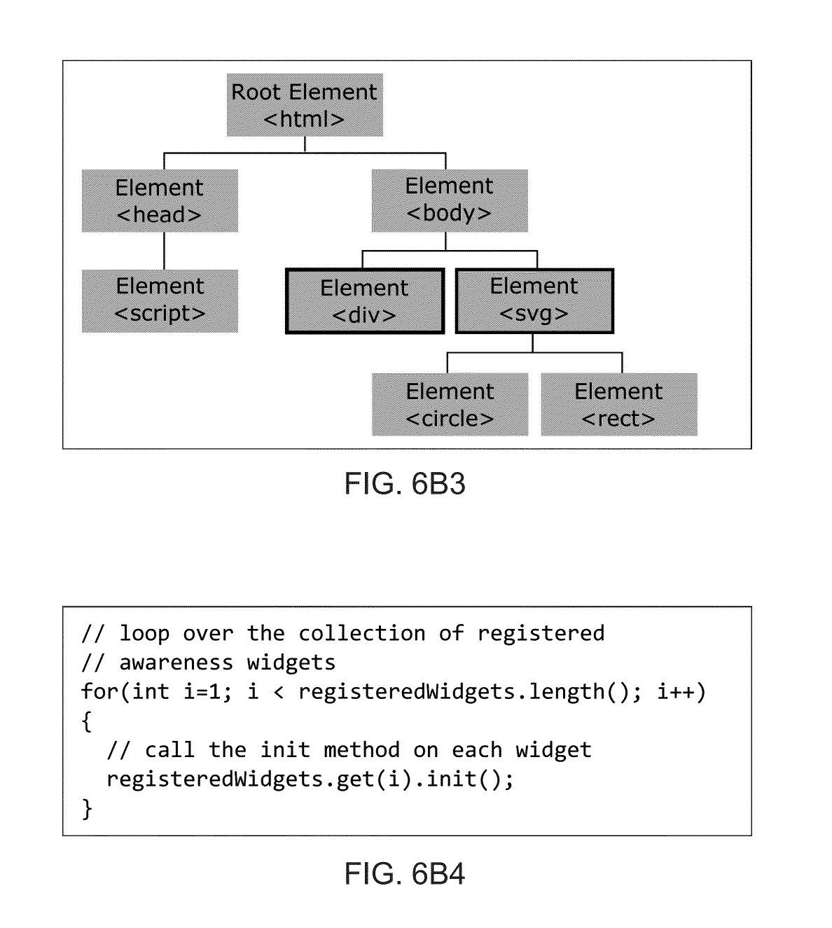

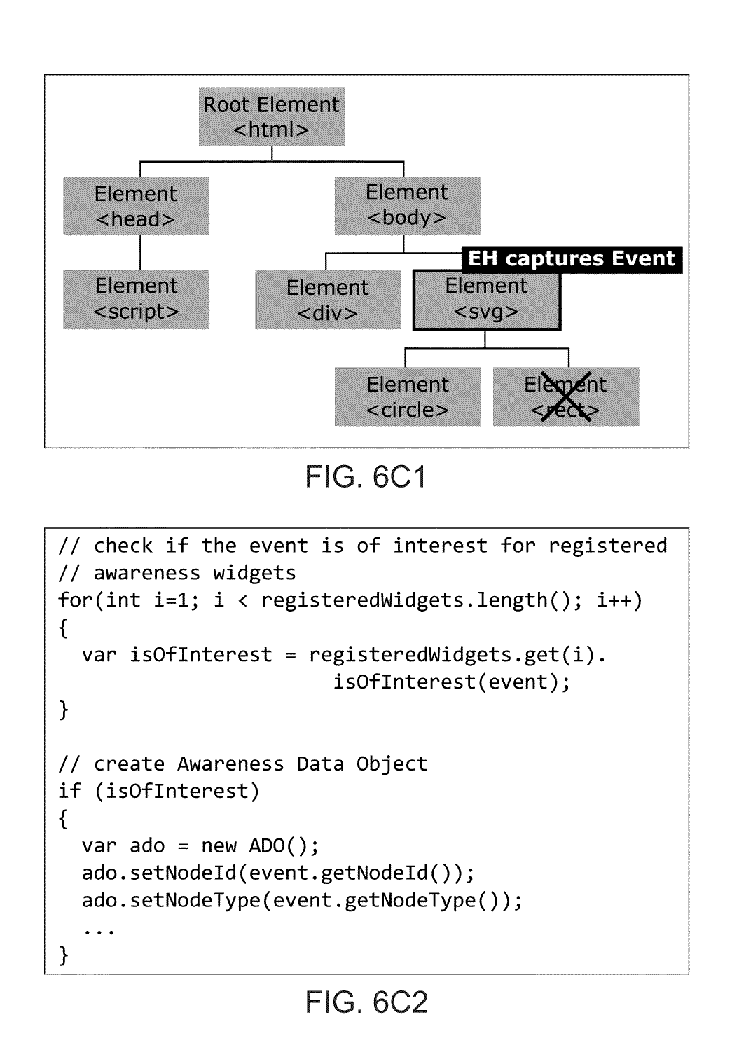

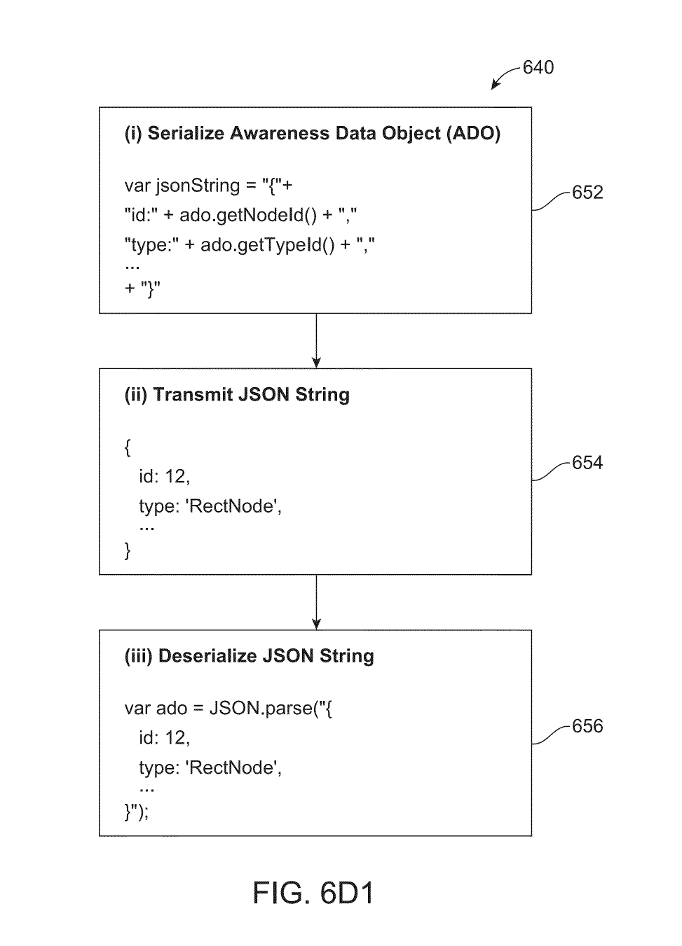

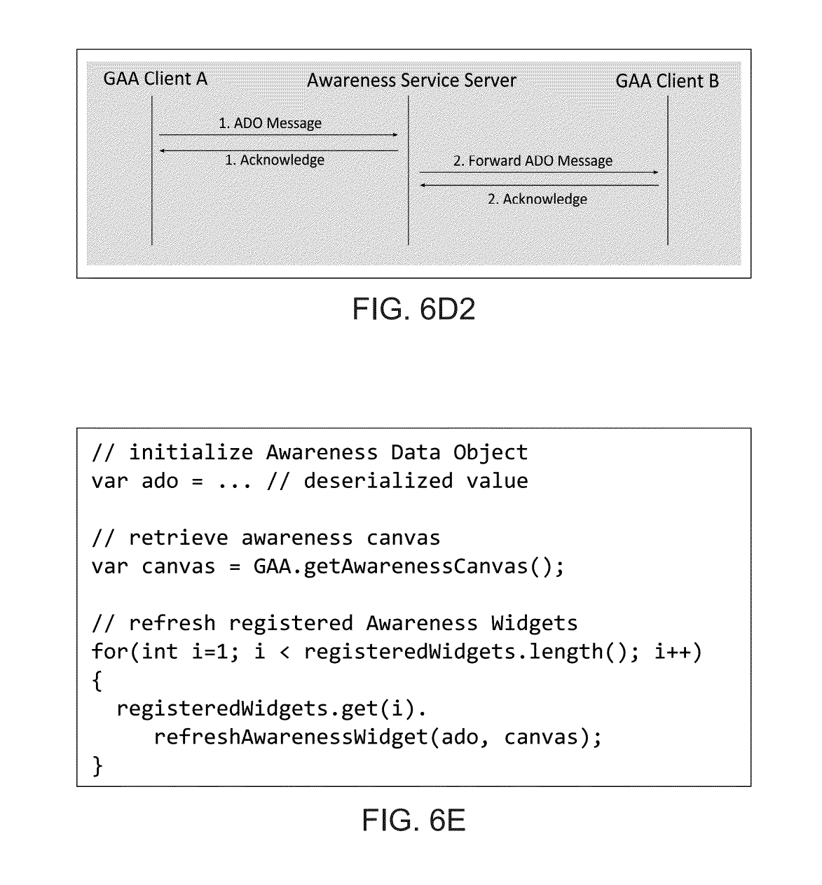

The particular embodiment of the GAA depicted in FIG. 2 is in charge of supporting the following processes: setting up the awareness system, capturing awareness information, propagating awareness messages, and preparing awareness information for their visualization. FIG. 6 provides an overview of the operation of the GAA. FIGS. 6A1-6E describe these four processes in detail.

Overview

As shown in FIG. 6, the GAA may function in an initialization mode 602 and in an operation mode 604. The initialization mode comprises an embedding and configuring process 610, and a setup process 620. The operation mode comprises a capture process 630, a messaging process 640, and a data preparation and visualization process 650.

The embedding and configuring process is shown in detail in FIGS. 6A1-6A3. Specifically, FIG. 6A1 shows embedding of the “gaa.js” and mark sync node.

FIG. 6A2 shows the DOM tree corresponding to the HTML of FIG. 6A1.

FIG. 6A3 shows an example configuration file referenced in the “gaa.js”. The configuration file defines the sync node to be used by the GAA. It can specify the file locations for the different awareness widgets contained in the GAA widget library (e.g. RegisterAwarenessWidget). It can specify the awareness widget to eventually be incorporated into the application (e.g. RequiredAwarenessWidget).

Setup Process

Once the web application including the integrated GAA is loaded by the browser, the GAA setup routine is triggered. First, this setup routine may establish a bi-directional communication channel to the awareness service server, for example using asynchronous JavaScript and XML (AJAX) techniques. This communication channel is dedicated to exchange messages with the central awareness service server.

FIG. 6B1 shows the next step, wherein IDs are added to the sync root nodes and child nodes of the DOM tree of FIG. 6A2. The GAA creates an identifier (ID) for each DOM node, whereas corresponding DOM nodes get the same ID. As used herein, corresponding DOM nodes may be (1) physically unequal since they belong to different DOM tree instances, and be (2) are structure-wise equal (i.e. they reside on the same DOM tree hierarchy level and have the same position on this DOM tree hierarchy level). The number of DOM tree instances corresponds to the number of clients which share the same collaboration session since each client manages its own DOM tree.

Where there are at least two clients in a collaborative session, there are at least two browser instances, each having its own DOM representations of the application. The DOM representations are synchronized in a collaborative systems (e.g. by a synchronization service). To allow the awareness adapter to refer to a dedicated DOM node with the same ID at every site, the DOM node IDs may be assigned in the same way at the sites. An ID distribution scheme ensures that structure-wise equal nodes (i.e. residing on the same tree hierarchy level and having the same position on this tree hierarchy level) get to the same ID.

FIG. 6B2 shows the next step, wherein DOM event handlers are registered to sync root nodes. The GAA adds DOM manipulation event listeners to the application root nodes which identify the specific DOM subtree encompassing the application. Application root nodes are defined in the “gaa.conf” file. In this manner, application-specific DOM manipulations (e.g. of type DOMNodeInserted, DOMNodeRemoved, DOMAttrModified, or DOMCharacterDataModified), can be monitored.

FIG. 6B3 shows addition to the DOM tree, of the Element <div> node representing the awareness canvas. Visualization of awareness information (e.g. a pointer, cursor, input highlighting) can eventually be drawn onto this dedicated canvas.

Next, the GAA also executes the setup routine of registered awareness widgets (e.g. document history, participant list, etc.) provided by the awareness widget itself. FIG. 6B4 shows an example of a setup routine.

Capture Process

After the initial setup step, the GAA monitors DOM manipulations. Examples of such manipulations include but are not limited to adding a DOM node or changes to a text node. This monitoring component leverages the registered DOM event handlers.

FIG. 6C1 shows the permanent DOM manipulation monitoring. This particular example shows the deletion of the <rect> node of the original DOM tree.

FIG. 6C2 shows the processing of the fired DOM event. Once a DOM manipulation event is fired, the responsible event handler checks whether the DOM change is of interest for one of the registered awareness widgets.

If this is the case, detailed information about the DOM change is retrieved (e.g. fetch the ID of the affected node, the old and new value, etc.). Change-related information may be serialized in JavaScript Object Notation (JSON) format.

As discussed above, embodiments may perform the capture process relying upon one or more of the following:
Document Object Model (DOM) Level 3 Core Specification (2004);
Document Object Model (DOM) Level 3 Events Specification (2011);
HTML Editing APIs, Work in Progress, e.g. most recent update 19 Jan. 2012.

Messaging Process

FIG. 6D1 shows an overview of a messaging process 640. FIG. 6D2 shows the messaging protocol to distribute awareness information in the form of ADO messages.

The messaging process is executed by the client-side GAA as well as the server. The messaging process may take place according to a serialize-transmit-deserialize procedure.

Specifically, in a first step 652 the awareness data object is serialized. In a second step 654, the JSON string is transmitted.

The GAA thus takes the JSON data, serializes it to a JSON string, and sends it to the server using the established communication channel. The server distributes the awareness messages to other clients sharing the same collaboration session except the sending client.

In a third step 656, the JSON string is deserialized. In particular, after an awareness message is received by a client, the GAA deserializes the JSON string into a JavaScript object.

Messaging according to embodiments may utilize the application/json Media Type for JavaScript Object Notation (JSON). RFC 4627 (Informational), of July 2006.

Data Preparation and Visualization Process

JavaScript objects created by the messaging component (e.g. ADOs), represent the shared data that can be consumed by awareness widgets registered in the library of the GAA. These registered awareness widgets check whether the provided information is of interest. FIG. 6E shows the process of initializing and providing Awareness Data Object to registered awareness widgets.

If the provided information is of interest, awareness widgets exploit value objects to feed their drawing methods and eventually present the user the proper awareness information. For example a workspace awareness widget employing a labeled pointer, may use new mouse coordinates to update its position. Similarly, a workspace awareness widget employing input highlighting, may use the information about newly created characters to highlight them. The drawing methods of the various registered awareness widgets use the same visualization canvas.

Embodiments may perform the awareness data preparation and visualization process according to one or more of the following:
Document Object Model (DOM) Level 3 Core Specification (2004);
Document Object Model (DOM) Level 3 Events Specification (2011);
Document Object Model (DOM) Level 2 Traversal and Range Specification (2000);
CSSOM View Module (e.g. Working Draft 4 Aug. 2011);
Scalable Vector Graphics (SVG) 1.0 Specification (2001);

Systems and methods providing generic workspace awareness support according to various embodiments, may offer certain benefits. For example certain embodiments may allow software reuse, as well as the benefits associated therewith including accelerated software development, and cost-efficient software maintenance.

Owing to its non-invasive approach, particular embodiments can enrich existing web applications, as well as newly developed web applications, without requiring source code changes or additional deployment steps. Therefore, web applications can even be enriched with awareness support at runtime.

Moreover, embodiments may allow the introduction of novel awareness widgets at runtime. Thus, the proposed embodiments may offer enhanced flexibility with respect to the software development lifecycle (allowing addition at runtime instead of design time), and also with respect to the feature comprehensiveness (since new awareness widgets can be added or removed to the GAS at runtime).

Another potential benefit is reduction in required runtime. Rather than resorting to a JAVA virtual machine, embodiments may ask for a regular browser with a JavaScript engine.

Another benefit is broad potential applicability. In particular, embodiments may be generally applicable to the majority of web-based applications complying with the W3C DOM standard.

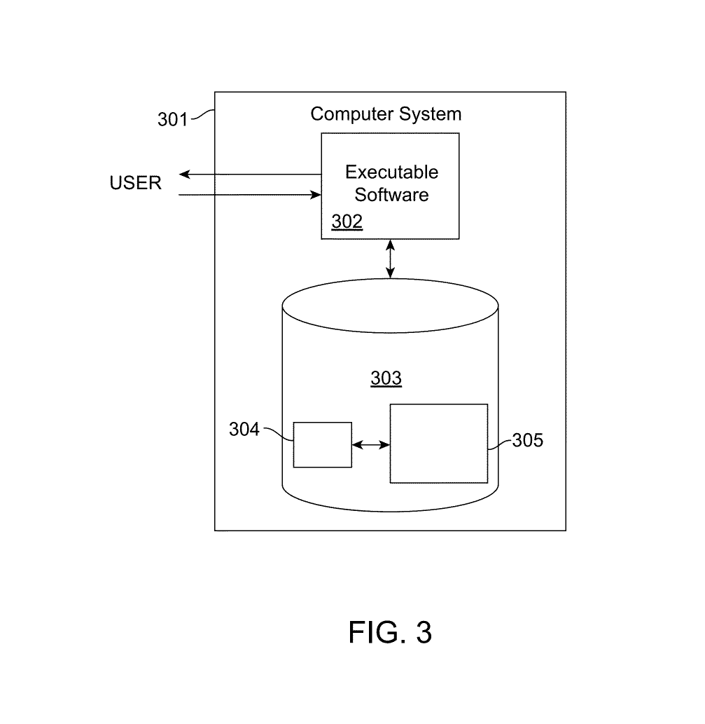

FIG. 3 illustrates hardware of a special purpose computing machine configured to perform generic workspace awareness support according to an embodiment. In particular, computer system 301 comprises a processor 302 that is in electronic communication with a non-transitory computer-readable storage medium 303. This computer-readable storage medium has stored thereon code 305 corresponding to generic awareness adapter. Code 304 corresponds to a non-editor specific W3C API. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

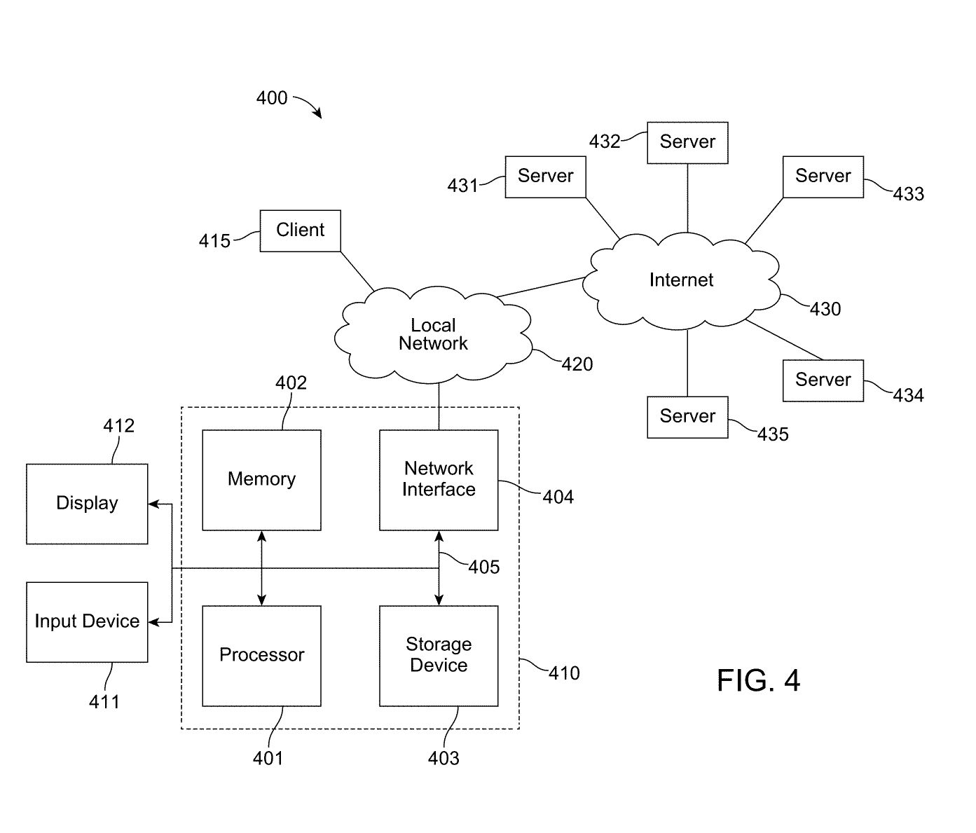

An example computer system 410 is illustrated in FIG. 4. Computer system 410 includes a bus 405 or other communication mechanism for communicating information, and a processor 401 coupled with bus 405 for processing information. Computer system 410 also includes a memory 402 coupled to bus 405 for storing information and instructions to be executed by processor 401, including information and instructions for performing the techniques described above, for example. This memory may also be used for storing variables or other intermediate information during execution of instructions to be executed by processor 401. Possible implementations of this memory may be, but are not limited to, random access memory (RAM), read only memory (ROM), or both. A storage device 403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 403 may include source code, binary code, or software files for performing the techniques above, for example. Storage device and memory are both examples of computer readable mediums.

Computer system 410 may be coupled via bus 405 to a display 412, such as a cathode ray tube (CRT) or liquid crystal display (LCD), for displaying information to a computer user. An input device 411 such as a keyboard and/or mouse is coupled to bus 405 for communicating information and command selections from the user to processor 401. The combination of these components allows the user to communicate with the system. In some systems, bus 405 may be divided into multiple specialized buses.

Computer system 410 also includes a network interface 404 coupled with bus 405. Network interface 404 may provide two-way data communication between computer system 410 and the local network 420. The network interface 404 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 404 sends and receives electrical, electromagnetic, or optical signals that carry digital data streams representing various types of information.

Computer system 410 can send and receive information, including messages or other interface actions, through the network interface 404 across a local network 420, an Intranet, or the Internet 430. For a local network, computer system 410 may communicate with a plurality of other computer machines, such as server 415. Accordingly, computer system 410 and server computer systems represented by server 415 may form a cloud computing network, which may be programmed with processes described herein. In the Internet example, software components or services may reside on multiple different computer systems 410 or servers 431-435 across the network. The processes described above may be implemented on one or more servers, for example. A server 431 may transmit actions or messages from one component, through Internet 430, local network 420, and network interface 404 to a component on computer system 410. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing a generic awareness adapter in communication with a non-editor specific layer of a web application, the generic awareness adapter comprising an awareness widget library, a capture component, and a message component;
causing the capture component to capture awareness information communicated from an editor-specific layer to the non-editor specific layer; and
causing the message component to reference the awareness widget library and transmit to an awareness service server, an awareness message based upon the awareness information, such that the awareness service server is caused to distribute the awareness message to other clients.

2. A method as in claim 1 wherein:
the non-editor specific layer comprises a world wide web consortium application programming interface (W3C API); and
the awareness information comprises a document object model (DOM) manipulation.

3. A method as in claim 2 wherein the DOM manipulation occurs according to a DOM Core specification and/or to a DOM Events specification.

4. A method as in claim 1 wherein:
the awareness information comprises JavaScript Object Notation (JSON) data;
the awareness message comprises a JSON string; and
the method further comprises causing the message component to serialize the JSON data into the JSON string.

5. A method as in claim 1 wherein the generic awareness adapter further comprises a visualization component configured to communicate the awareness message to an awareness widget of the awareness widget library for visualization.

6. A method as in claim 5 wherein the awareness widget library includes a pointer awareness widget, a cursor awareness widget, a document history awareness widget, an annotated thumbnail view awareness widget, or a text highlight awareness widget.

7. A method as in claim 1 wherein providing the generic awareness adapter in communication with the non-editor specific layer, comprises:
embedding an extra file name into the web application; and
completing a specific configuration file.

8. A non-transitory computer readable storage medium embodying a computer program for performing a method, said method comprising:
providing a generic awareness adapter in communication with a non-editor specific layer of a web application, the generic awareness adapter comprising an awareness widget library, a capture component, and a message component;
causing the capture component to capture awareness information communicated from an editor-specific layer to the non-editor specific layer; and
causing the message component to reference the awareness widget library and transmit to an awareness service server, an awareness message based upon the awareness information, such that the awareness service server is caused to distribute the awareness message to other clients.

9. A non-transitory computer readable storage medium as in claim 8 wherein:
the non-editor specific layer comprises a world wide web consortium application programming interface (W3C API); and
the awareness information comprises a document object model (DOM) manipulation.

10. A non-transitory computer readable storage medium as in claim 9 wherein the DOM manipulation occurs according to a DOM Core specification and/or to a DOM Events specification.

11. A non-transitory computer readable storage medium as in claim 8 wherein:
the awareness information comprises JavaScript Object Notation (JSON) data;
the awareness message comprises a JSON string; and
the method further comprises causing the message component to serialize the JSON data into the JSON string.

12. A non-transitory computer readable storage medium as in claim 8 wherein the generic awareness adapter further comprises a visualization component configured to communicate the awareness message to an awareness widget of the awareness widget library for visualization.

13. A non-transitory computer readable storage medium as in claim 12 wherein the awareness widget library includes a pointer awareness widget, a cursor awareness widget, a document history awareness widget, an annotated thumbnail view awareness widget, or a text highlight awareness widget.

14. A non-transitory computer readable storage medium as in claim 8 wherein providing the generic awareness adapter in communication with the non-editor specific layer, comprises:
embedding an extra file name into the web application; and
completing a specific configuration file.

15. A computer system comprising:
one or more processors;
a software program, executable on said computer system, the software program configured to:
provide a generic awareness adapter in communication with a non-editor specific layer of a web application, the generic awareness adapter comprising an awareness widget library, a capture component, and a message component;
cause the capture component to capture awareness information communicated from an editor-specific layer to the non-editor specific layer; and
cause the message component to reference the awareness widget library and transmit to an awareness service server, an awareness message based upon the awareness information, such that the awareness service server is caused to distribute the awareness message to other clients.

16. A computer system as in claim 15 wherein:
the non-editor specific layer comprises a world wide web consortium application programming interface (W3C API); and
the awareness information comprises a document object model (DOM) manipulation.

17. A computer system as in claim 16 wherein the DOM manipulation occurs according to a DOM Core specification and/or to a DOM Events specification.

18. A computer system as in claim 15 wherein:
the awareness information comprises JavaScript Object Notation (JSON) data;
the awareness message comprises a JSON string; and
the method further comprises causing the message component to serialize the JSON data into the JSON string.

19. A computer system as in claim 15 wherein the generic awareness adapter further comprises a visualization component configured to communicate the awareness message to an awareness widget of the awareness widget library for visualization.

20. A computer system as in claim 19 wherein the awareness widget library includes a pointer awareness widget, a cursor awareness widget, a document history awareness widget, an annotated thumbnail view awareness widget, or a text highlight awareness widget.
